(19) United States
(12) Patent Application Publication
(10) Pub. No.: US 2007/0092622 A1
(43) Pub. Date: Apr. 26, 2007

(54) Composition containing pectin ester

(76) Inventors: Jens Eskil Trudsoe, Roskilde (DK); Jan Larsen, Valby (DK)

Correspondence Address: David M. Goodrich, Esq.;J.M. Huber Corporation, 333 Thornal Street, Edison, NJ, 08837-2220, US

(21) Appl. No.: 11/258,439

(22) Filed: Oct. 25, 2005

(51) Int. Cl. A23L 1/05

(52) U.S. Cl. 426/577

(57) ABSTRACT

Disclosed is a skin-protecting alkalinity-controlling composition comprising propylene glycol pectin having a degree of esterification in the range from about 30% to about 100%.

### BACKGROUND OF THE INVENTION

Pectin is a complex polysaccharide associated with plant cell walls, with the middle lamella layer of the cell wall the richest in pectin. Pectins are produced and deposited during cell wall growth and are particularly abundant in soft plant tissues under conditions of fast growth and high moisture content.

Pectin consists of an alpha 1-4 linked polygalacturonic acid backbone intervened by rhamnose residues and modified with neutral sugar side chains and non-sugar components such as acetyl, methyl, and ferulic acid groups. The neutral sugar side chains, which include arabinan and arabinogalactans, are attached to the rhamnose residues in the backbone. The rhamnose residues tend to cluster together on the backbone.

The galacturonic acid residues in pectin are partly esterified and present as the methyl ester. The degree of esterification is defined as the percentage of carboxyl groups esterified. Pectin with a degree of esterification (“DE”) above 50% is named high methyl ester (“HM”) pectin or high ester pectin and one with a DE lower than 50% is referred to as low methyl ester (“LM”) pectin or low ester pectin.

Pectins are most stable at pH 3-4. Below pH 3, methoxyl and acetyl groups and neutral sugar side chains are removed. At elevated temperatures, these reactions are accelerated and cleavage of glycosidic bonds in the galacturonan backbone occurs. Under neutral and alkaline conditions, methyl ester groups are saponified and the polygalacturonan backbone breaks through beta-elimination-cleavage of glycosidic bonds at the non-reducing ends of methoxylated galacturonic acid residues. These reactions also proceed faster with increasing temperature. Pectic acids and LM pectins are resistant to neutral and alkaline conditions since there are no or only limited numbers of methyl ester groups.

Pectin is a weak acid, and is less soluble at low pH than at high pH. Thus, by changing the pH of the pectin during manufacture thereof, a pectin having lower or higher solubility is provided. The pH is typically increased through the use of bases such as alkali metal hydroxides or alkali metal carbonates, but other bases are equally useable. For instance, by using sodium carbonate, sodium pectinate is formed and the higher the dosage of sodium carbonate and, thus, the higher the pH, the more of the carboxylic acids are transformed to their sodium salts. However, at higher pH the pectin starts to de-esterify during pH-adjustment, handling and storage. Thus the pH should be maintained at a level at or below pH 6.

Historically, pectin has mainly been used as a gelling agent for jam or similar, fruit-containing, or fruit-flavoured, sugar-rich systems. Examples are traditional jams, jams with reduced sugar content, clear jellies, fruit-flavoured confectionery gels, non-fruit-flavoured confectionery gels, heat-reversible glazing for the bakery industry, heat-resistant jams for the bakery industry, ripples for use in ice cream, and fruit preparations for yoghurt. A substantial portion of pectin is used today for stabilization of low-pH milk drinks, including fermented drinks and mixtures of fruit juice and milk.

Pectin and other polysaccharides have also been proposed for possible use in personal care compositions and household products, such as skin cremes and lotions. Patents and other publications describing the role of pectin in such compositions are set forth in greater detail in Danish Patent Application No. PA2004/00649, now also PCT Patent Application DK2005/000285, which is hereby incorporated by reference. There is a continuing interest for new personal care products such as skin cremes that treat skin irritation and provide skin protection.

Skin has a protective layer on its surface called the “acid mantle” that is a mixture of sebum and sweat which are excreted by sebaceous glands and sweat glands located throughout the dermal layer of skin, just below its surface. In addition to helping protect skin from “the elements” (such as wind or pollutants), the acid mantle also inhibits the growth of harmful bacteria and fungi. If the acid mantle is disrupted or loses its acidity, the skin becomes more prone to damage and infection. The loss of acid mantle is one of the side effects of washing the skin with soaps or detergents of moderate or high strength as upon washing with soap, a pH of 8-10 is established in the wash liquor. This alkalinity neutralizes the natural acid mantle of the skin (pH 5-6). Although in normal skin this acid mantle is reformed relatively quickly, in sensitive or pre-damaged skin irritations may result. A further disadvantage of soaps is the formation of insoluble lime soaps in hard water. Being alkaline, soap emulsifies the oily layer covering the natural horny layer (stratum corneum) of a person's skin and neutralizes a likewise natural acid mantle of the epidermis, which has, normally, an acid pH of approximately 5.5-6.5. Failure to readily regenerate the acid and oily part of the epidermis—particularly among older people—often results in dermatological symptoms, such as itching, chapping and cracking of the epidermis, especially in cold weather. Of course, always to be considered is that significant segment of the population, which is allergic to or cannot tolerate conventional soaps in view of a number of reactions (sensitivities) resulting from the use thereof.

A need for a composition remains, which is capable of providing buffering, thus avoiding a major increase in the pH of an aqueous system and/or useable for reducing the pH of aqueous systems, in which alkalinity is formed as a result of chemical and/or biological reactions, or as a result of alkalinity being imposed on the aqueous system by the environment. In particular, there is a need for a composition, which will protect the acid mantle, and there is a need for incorporating such a composition in articles, which are in contact with the skin, either human skin or animal skin.

### BRIEF SUMMARY OF THE INVENTION

The present invention relates to a skin-protecting alkalinity-controlling composition comprising propylene glycol pectin having a degree of esterification (DE) in the range from about 30% to about 100%.

The present invention also relates to a skin-protecting alkalinity-controlling composition comprising: (1) about 0.1% to about 2% of a propylene glycol pectin having a degree of esterification (DE) in the range from about 30% to about 100%, and a DPGE of about 5% to about 100%; and (2) a low DE carboxylic acid polysaccharide having a degree of esterification in the range from about 5% to about 70%.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings:

FIG. 1 shows the alkali consumption of propylene glycol pectins of different degrees of esterification,

FIG. 2 shows the alkali consumption of propylene glycol pectins having different starting degrees of esterification,

FIG. 3 shows the pH-drop of propylene glycol pectins of different degrees of esterification,

FIG. 4 shows the pH-drop of the propylene glycol pectins of FIG. 3 having a 75% DE, but having different starting degrees of esterification,

FIG. 5 shows the pH drop of the propylene glycol pectins having a 75% DE, with the pH drop performance being measured at two different temperatures, 30-32° C. and 45-47° C.,

FIG. 6 shows the pH drop of the propylene glycol pectin solutions prepared by dissolution at 25° C. and 70° C.,

FIG. 7 shows the effect of propylene glycol pectin concentration on pH drop (using a pH drop index),

FIG. 8, shows the effect of dissolution temperature and multiple alkali additions on pH drop,

FIG. 9, shows the identical results to FIG. 8, but using a normalized pH-drop index,

FIG. 10, shows the comparative alkali consumption of three different materials, methyl pectin, propylene glycol pectin (as described in the present invention), and propylene glycol alignate,

FIG. 11, shows the comparative pH-drop performance of three different materials, methyl pectin, propylene glycol pectin (as described in the present invention), and propylene glycol alignate.

### DETAILED DESCRIPTION OF THE INVENTION

The skin-protecting alkalinity-controlling composition according to the invention comprises a high DE propylene glycol pectin, which can be applied to the skin of humans or animals. Uses include but are not limited to lotions, creams, foundations, face masks, hair care products, genital lotions, deodorants, ostomy products, feminine hygiene products, laundry products, bath salt products, soap products, fragrance products, lotionized tissue products, and shaving products. Further, such pectin can be used in similar products to treat animals.

Compared to other carboxylic acid polysaccharides, like methylated pectin and propylene glycol alginate, propylene glycol pectin prepared according to the present invention provides a higher level of alkali consumption than methylated pectin at a similar total degree of esterification. Similarly there is a clear superiority of alkali consumption between propylene glycol pectin and propylene glycol alginate, with propylene glycol pectin providing a significantly higher level of alkali consumption.

However, under certain circumstances, the other carboxylic acid polysaccharides can be more effective at reducing pH than propylene glycol pectin. Propylene glycol alginate is more effective in reducing pH than methylated pectin, which in turn is more effective than propylene glycol pectin. However, propylene glycol pectin still provides superior performance because it is possible to achieve higher degrees of esterification than what is possible using conventional techniques for producing methylated pectin. For example, propylene glycol pectin having a total degree of esterification of above 90% is both easily achievable and provides more effective pH reducing performance conventionally produced methylated pectin having a degree of esterification of about 70%. (All of the aforementioned results are discussed in greater detail below in Examples 1 and 7).

Accordingly, the propylene glycol pectin prepared according to the present invention will have a high degree of esterification (“DE”). Preferably the DE will be in the range of from about 30% to about 100%, more preferably from about 80% to about 100%.

Additionally it has also been determined that at equal amounts of degree of esterification, the alkali consumption increases with decreasing degree of propylene glycol esterification (“DPGE”) (see Example 1). Accordingly, it is preferred that the DPGE should be relatively low, between about 5% and about 100%, preferably between about 10% and about 90%, more preferably between about 30% and about 90%, even more preferably between about 70% and about 90%.

In a preferred embodiment according to the invention, the skin-protecting alkalinity controlling composition further comprises at least one low DE-carboxylic acid polysaccharide having a degree of esterification (DE) in the range from about 5 to about 70%, more preferably from about 5 to about 40%, most preferably from 10 to about 35%. A carboxylic acid polysaccharide having a relatively low DE provides for a large alkali consumption capacity or buffer capacity.

An advantage of a higher buffer capacity is the ability of the pectin to neutralize an initial high concentration of alkali. This is an advantage particularly when fabrics are insufficiently depleted for alkaline washing powder. Thus, by combining a low DE and a high DE carboxylic acid polysaccharide, an initial alkali consumption buffering can be obtained succeeded by a pH-reduction.

The propylene glycol pectin may also be supplemented by one or more additional high DE carboxylic acid polysaccharides.

The additional high DE carboxylic acid polysaccharides and low DE carboxylic acid polysaccharides may be selected from the group comprising pectin esters, alginic acid esters, esterified cellulose ethers, esterified hydroxyethylcellulose, esterified carboxymethylcellulose, esterified guar gum, esterified cationic guar gum, esterified hydrocypropyl guar gum, starch esters, and polymerized sugar esters.

In one embodiment according to the invention, any of said additional high DE carboxylic acid polysaccharides and said low DE carboxylic acid polysaccharides is a pectin ester, preferably a pectin ester of aliphatic, arylaliphatic, cycloaliphatic or heterocyclic alcohols, more preferably an ester of methanol, ethanol, propanol or isopropanol, and most preferably an ester of methanol.

In a more particular embodiment according to the invention, any of the additional high DE carboxylic acid polysaccharides, and the low DE carboxylic acid polysaccharides is a pectin having a molecular weight in the range from about 5,000 to about 140,000, preferably in the range from about 10,000 to about 125,000, most preferably in the range from about 10,000 to about 40,000.

In a preferred embodiment of the invention, any of said esterified alginic acids is an alginic acid ester of aliphatic, aromatic, araliphatic, alicyclic and heterocyclic alcohols, including esters deriving from substituted alcohols such as esters of bivalent aliphatic alcohols, preferably ethylene glycol or propylene glycol alginate. U.S. Pat. No. 5,416,205 discloses suitable alginic acid derivatives, and the reference is enclosed herewith in its entirety.

The skin-protecting, alkalinity-controlling compositions according to the invention are particularly suitable for use in personal care products. In a preferred embodiment, said products are for use on human skin. In another embodiment, said products are for use on animal skin. Preferably, the propylene glycol pectin is present in a concentration of about 0.1% to about 2% (more preferably in a concentration of about 0.1% to about 1%) of the skin-protecting, alkalinity-controlling compositions.

In a particular embodiment according to the invention, the skin protecting alkalinity-controlling composition is used in a product selected from the group consisting of skin creams, skin lotions, deodorant products, fragrance products, hair care products, shaving products, soap products, and bath salt products.

In another embodiment according to the invention, the skin protecting alkalinity-controlling composition is used in a product selected from the group consisting of female hygiene products and diapers.

A particular advantage of the present composition is the fact that they are capable of controlling the alkalinity of the surface, to which they are applied, for a prolonged time. As demonstrated in examples 5 and 8, the carboxylic acid polysaccharides are capable of controlling the alkalinity at multiple challenges of alkalinity. This fact can be utilized in e.g. deodorant products, diapers or female hygiene products, which are repeatedly exposed to sweat that is decomposed by micro-organisms to alkaline substances. Thus, a prolonged effective alkalinity control may be obtained by the products according to the present invention.

In another embodiment according to the invention, the skin-protecting alkalinity-controlling composition is used in a product selected from the group consisting of ostomy products and wound care products.

In ostomy products a low solubility polysaccharide, such as a low solubility pectin, should be used, since the ostomy product should remain insoluble for a longer period of time during flushing by body fluids. In this particular case a combination of a low DE and a low pH pectin would provide for a longer durability of the ostomy product during use.

In still another embodiment according to the invention, the skin-protecting alkalinity-controlling composition is used in a product selected from the group consisting of lotionized tissue products, fabric treating products, and laundry rinse products.

The following experimental materials and methods were used in carrying out the present experiments. Additional experimental methods are introduced in the specific examples section below.

Determination of degree of esterification (DE) and galacturonic acid (GA) in non-amide pectin.

Principle:

This method pertains to the determination of % DE and % GA in pectin, which does not contain amide and acetate ester.

Apparatus:

1. Analytical balance

2. Glass beaker, 250 ml, 5 pieces

3. Measuring glass, 100 ml

4. Vacuum pump

5. Suction flask

6. Glass filter crucible no. 1 (Büichner funnel and filter paper)

7. Stop watch

8. Test tube

9. Drying cabinet at 105° C.

10. Dessicator

11. Magnetic stirrer and magnets

12. Burette (10 ml, accuracy ±0,05 ml)

13. Pipettes (20 ml: 2 pieces, 10 ml: 1 piece)

14. pH-meter/autoburette or phenolphtalein

Chemicals:

1. Carbon dioxide-free water (deionized water)

2. Isopropanol (IPA), 60% and 100%

3. Hydrochloride (HCl), 0.5 N and fuming 37%

4. Sodium hydroxide (NaOH), 0.1 N (corrected to four decimals, e.g. 0.1002), 0.5 N

5. Silver nitrate (AgNO₃), 0.1 N

6. Nitric acid (HNO₃), 3 N

7. Indicator, phenolphtalein, 0.1%

Procedure—Determination of % DE and % GA (Acid alcohol: 100 ml 60% IPA+5 ml HCl fuming 37%):

1. Weigh 2.0000 g pectin in a 250 ml glass beaker.

2. Add 100 ml acid alcohol and stir on a magnetic stirrer for 10 min.

3. Filtrate through a dried, weighed glass filter crucible.

4. Rinse the beaker completely with 6×15 ml acid alcohol.

5. Wash with 60% IPA until the filtrate is chloride-free (approximately 500 ml).

6. Wash with 20 ml 100% IPA.

7. Dry the sample for 2½hours at 105° C.

8. Weigh the crucible after drying and cooling in desiccator.

9. Weigh accurately 0.4000 g of the sample in a 250 ml glass beaker.

10. Weigh two samples for double determination. Deviation between double determinations must max. be 1.5% absolute. If deviation exceeds 1.5% the test must be repeated.

11. Wet the pectin with approx. 2 ml 100% IPA and add approx. 100 ml carbon di-oxide-free, deionized water while stirring on a magnetic stirrer.

(Chloride test on ash-free and moisture-free basis: Transfer approximately 10 ml filtrate to a test tube, add approximately 3 ml 3 N HNO₃, and add a few drops of AgNO₃. The filtrate will be chloride-free if the solution is clear, otherwise there will be a precipitation of silver chloride.)

The sample is now ready for titration, either by means of an indicator or by using a pH-meter/autoburette.

Procedure—Determination of % DE only

(Acid alcohol: 100 ml 60% IPA+5 ml HCl fuming 37%):

1. Weigh 2.00 g pectin in a 250 ml glass beaker.

2. Add 100 ml acid alcohol and stir on a magnetic stirrer for 10 minutes.

3. Filtrate through a Büchner funnel with filter paper.

4. Rinse the beaker with 90 ml acid alcohol.

5. Wash with 1000 ml 60% IPA.

6. Wash with approximately 30 ml 100% IPA.

7. Dry the sample for approximately 15 minutes on Büchner funnel with vacuum suction.

8. Weigh approximately 0.40 g of the sample in a 250 ml glass beaker.

9. Weigh two samples for double determination. Deviation between double determinations must max. be 1.5% absolute. If deviation exceeds 1.5% the test must be repeated.

10. Wet the pectin with approximately 2 ml 100% IPA and add approx. 100 ml de-ionized water while stirring on a magnetic stirrer.

The sample is now ready for titration, either by means of an indicator or by using a pH-meter/autoburette.

(Note: It is very important that samples with % DE<10% are titrated very slowly, as the sample will only dissolve slowly during titration.)

Titration using indicator:
1. Add 5 drops of phenolphtalein indicator and titrate with 0.1 N NaOH until change of color (record it as V₁ titer).
2. Add 20.00 ml 0.5 N NaOH while stirring. Let stand for exactly 15 min. When standing the sample must be covered with foil.
3. Add 20.00 ml 0.5 N HCl while stirring and stir until the color disappears.
4. Add 3 drops of phenolphtalein and titrate with 0,1 N NaOH until change of color (record it as V₂ titer).

Blind test (Double determination is carried out):

1. Add 5 drops phenolphtalein to 100 ml carbon dioxide-free or dionized water (same type as used for the sample), and titrate in a 250 ml glass beaker with 0.1 N NaOH until change of color (1-2 drops).

2. Add 20.00 ml 0.5 N NaOH and let the sample stand untouched for exactly 15 minutes. When standing the sample must be covered with foil.

3. Add 20.00 ml 0.5 N HCl and 3 drops phenolphtalein, and titrate until change of color with 0.1 N NaOH (record it as B₁). Maximum amount allowed for titration is 1 ml 0.1 N NaOH. If titrating with more than 1 ml, 0.5 N HCl must be diluted with a small amount of deionized water. If the sample has shown change of color on addition of 0.5 N HCl, 0.5 N NaOH must be diluted with a small amount of carbon dioxide-free water. Maximum allowed dilution with water is such that the solutions are between 0.52 and 0.48 N.

Titration using pH-meter/Autoburette:

Using Autoburette type ABU 80 the following settings may be applied:

| Sample with | % DE <10 | Blind test |
|---|---|---|
| Proportional band | 0.5 | 5 |
| Delay sec. | 50 | 5 |
| Speed-V1 | 10 | 5 |
| Speed-V2 | 15 | 5 |

1. Titrate with 0.1 N NaOH to pH 8.5 (record the result as V₁ titer).

2. Add 20.00 ml 0.5 N NaOH while stirring, and let the sample stand without stir-ring for exactly 15 minutes. When standing the sample must be covered with foil.

3. Add 20.00 ml 0.5 N HCl while stirring and stir until pH is constant.

4. Subsequently, titrate with 0.1 N NaOH to pH 8.5 (record the result as V₂ titer).

Blind test (Double determination is carried out):
1. Titrate 100 ml carbon dioxide-free or deionized (same type as used for the sample) water to pH 8.5 with 0.1 N NaOH (1-2 drops).
2. Add 20.00 ml 0.5 N NaOH while stirring and let the blind test sample stand without stirring for exactly 15 min. When standing the sample must be covered with foil.
3. Add 20.00 ml 0.5 N HCl while stirring, and stir until pH is constant.
4. Titrate to pH 8.5 with 0.1 N NaOH (record it as B₁). Maximum amount allowed for titration is 1 ml 0.1 N NaOH. If titrating with more than 1 ml, 0.5 N HCl must be diluted with a small amount of deionized water. If pH does not fall to below 8.5 on addition of 0.5 N HCl, 0.5 N NaOH must be diluted with a small amount of carbon dioxide-free water. Maximum allowed dilution with water is such that the dilutions are between 0.52 and 0.48 N.

Calculation:
Vₜ=V₁+(V₂−B₁)
% DE (Degree of Esterification)={(V₂−B₁)×100}/Vₜ
% DFA (Degree of Free Acid)=100—% DE
% GA* (Degree of Galacturonic acid)=(194.1×Vₜ×N×100) 400

194.1: Molecular weight for GA

N: Corrected normality for 0.1 N NaOH used for titration (e.g. 0.1002 N)

400: weight in mg of washed and dried sample for titration

% Pure pectin={(acid washed, dried amount of pectin)×100}/(weighed amount of pectin)

### EXAMPLES

Seven samples of propylene glycol pectin were prepared by the method set forth in U.S. Pat. No. 2,522,970 issued on Sep. 19, 1950 to Steiner et al. This method starts with dry pectin, from dried lemon peel, having a DE of 8.0%, 34.8%, and 63.5%.

15 g of the pectin was then washed in acidified alcohol (50 ml of concentrated HCl in 1000 ml of 60% isopropanol) for 10 minutes at room temperature while stirring. The washed pectin was drained on a Büichner funnel, washed first with 100 ml of the acidified alcohol and then with 1000 ml 60% isopropanol. The washed pectin was transferred to a stainless steel container to which was added 6 g of propylene oxide. The container was sealed and reaction took place at temperatures of 25° C. or 40° C. for time periods of 3 hours or 16 hours (see Table below). After reaction, the resulting product was suspended in 100% isopropanol and drained on a Büichner funnel. It was then washed with 200 ml isopropanol and dried for 2 hours and 30 minutes at 105° C.

The above process for producing propylene glycol pectin was repeated several times while varying the pectin starting DE %, the reaction temperature, and the reaction time as set forth in Table 1 below. Table 1 also lists the corresponding propylene glycol pectin composition that is produced as a result of the specific reaction conditions.

TABLE 1

| | | | | | Degree of |
|---|---|---|---|---|---|
| Reaction | Pectin starting | Reaction | Reaction time, | Propylene Glycol | Propylene Glycol |
| No. | DE, % | temperature, ° C. | hours | Pectin, total DE, % | Esterification |
| 1 | 63.5 | 25 | 3 | 74.2 | 10.7 |
| 2 | 63.5 | 40 | 3 | 85.2 | 21.7 |
| 3 | 34.8 | 40 | 3 | 75.0 | 40.2 |
| 4 | 34.8 | 25 | 3 | 56.1 | 21.3 |
| 5 | 8.0 | 40 | 6 | | |
| | | 25 | 16 | 95.3 | 87.3 |
| 6 | 8.0 | 40 | 3 | 75.3 | 67.3 |
| 7 | 8.0 | 25 | 3 | 37.9 | 29.9 |

### Example 1

### Effect of Degree of Esterification

The effect of the degree of esterification was evaluated by measuring the titration curves for each of the above samples. The titration curves were measured by the following experimental procedure:

Titration curves procedure

1. 2 g pectin was dissolved in 200 g. deionized water at 70° C. and at 20° C.

2. The solution was placed in a thermostatically controlled water bath at 25° C. and continuously stirred.

3. 0.1 M NaOH was added to the solution and pH recorded as a function of added 0.1 M NaOH.

The results are set forth below in table 2.

TABLE 2

| Reaction | | Reaction | | Reaction | | Reaction | | Reaction | | Reaction | | Reaction | |
|---|---|---|---|---|---|---|---|---|---|---|---|---|---|
| Sample 1 | | Sample 2 | | Sample 3 | | Sample 4 | | Sample 5 | | Sample 6 | | Sample 7 | |
| ml. 0.1 M | pH | ml. 0.1 M | pH | ml. 0.1 M | pH | ml. 0.1 M | pH | ml. 0.1 M | pH | ml. 0.1 M | pH | ml. 0.1 M | pH |
| 0 | 2.81 | 0 | 2.99 | 0 | 2.87 | 0 | 2.67 | 0 | 3.96 | 0 | 3.11 | 0 | 2.73 |
| 1 | 2.89 | 1 | 3.09 | 1 | 2.95 | 1 | 2.72 | 1 | 4.28 | 1 | 3.20 | 1 | 2.78 |
| 2 | 2.97 | 2 | 3.21 | 2 | 3.04 | 2 | 2.78 | 1.5 | 4.50 | 2 | 3.30 | 2 | 2.84 |
| 3 | 3.05 | 3 | 3.34 | 3 | 3.13 | 3 | 2.83 | 2 | 4.81 | 3 | 3.41 | 3 | 2.90 |
| 4 | 3.14 | 4 | 3.47 | 4 | 3.22 | 4 | 2.89 | 2.5 | 5.44 | 4 | 3.51 | 4 | 2.96 |
| 5 | 3.22 | 5 | 3.62 | 5 | 3.32 | 5 | 2.95 | 3 | 8.85 | 5 | 3.61 | 5 | 3.02 |
| 6 | 3.31 | 6 | 3.78 | 6 | 3.42 | 6 | 3.01 | 3.5 | 9.96 | 6 | 3.72 | 6 | 3.08 |
| 7 | 3.41 | 7 | 3.96 | 7 | 3.52 | 7 | 3.07 | | | 7 | 3.83 | 7 | 3.13 |
| 8 | 3.50 | 8 | 4.17 | 8 | 3.61 | 8 | 3.14 | | | 8 | 3.95 | 8 | 3.19 |
| 9 | 3.60 | 9 | 4.45 | 9 | 3.72 | 9 | 3.20 | | | 9 | 4.07 | 9 | 3.24 |
| 10 | 3.69 | 10 | 4.91 | 10 | 3.83 | 10 | 3.26 | | | 10 | 4.22 | 10 | 3.29 |
| 11 | 3.79 | 11 | 6.35 | 11 | 3.94 | 11 | 3.31 | | | 11 | 4.36 | 11 | 3.34 |
| 12 | 3.90 | 12 | 9.77 | 12 | 4.07 | 12 | 3.37 | | | 12 | 4.56 | 12 | 3.39 |
| 13 | 4.02 | 13 | 10.33 | 13 | 4.21 | 13 | 3.43 | | | 13 | 4.79 | 13 | 3.43 |
| 14 | 4.15 | | | 14 | 4.37 | 14 | 3.49 | | | 14 | 5.16 | 14 | 3.48 |
| 15 | 4.29 | | | 15 | 4.56 | 15 | 3.55 | | | 15 | 6.07 | 15 | 3.52 |
| 16 | 4.46 | | | 16 | 4.82 | 16 | 3.61 | | | 16 | 9.54 | 16 | 3.56 |
| 17 | 4.69 | | | 17 | 5.24 | 17 | 3.67 | | | 17 | 10.30 | 17 | 3.61 |
| 18 | 5.02 | | | 18 | 6.59 | 18 | 3.73 | | | | | 18 | 3.65 |
| 19 | 5.64 | | | 19 | 9.67 | 19 | 3.79 | | | | | 19 | 3.69 |
| 20 | 7.94 | | | | | 20 | 3.85 | | | | | 20 | 3.74 |
| 21 | 9.72 | | | | | 21 | 3.92 | | | | | 21 | 3.78 |
| 22 | | | | | | 22 | 3.98 | | | | | 22 | 3.82 |
| 23 | | | | | | 23 | 4.05 | | | | | 23 | 3.87 |
| 24 | | | | | | 24 | 4.13 | | | | | 24 | 3.92 |
| 25 | | | | | | 25 | 4.21 | | | | | 25 | 3.97 |
| 26 | | | | | | 26 | 4.29 | | | | | 26 | 4.02 |
| 27 | | | | | | 27 | 4.38 | | | | | 27 | 4.07 |
| 28 | | | | | | 28 | 4.48 | | | | | 28 | 4.12 |
| 29 | | | | | | 29 | 4.59 | | | | | 29 | 4.18 |
| 30 | | | | | | 30 | 4.72 | | | | | 30 | 4.23 |
| 31 | | | | | | 31 | 4.88 | | | | | 31 | 4.29 |
| 32 | | | | | | 32 | 5.10 | | | | | 32 | 4.35 |
| 33 | | | | | | 33 | 5.46 | | | | | 33 | 4.42 |
| 34 | | | | | | 34 | 6.18 | | | | | 34 | 4.48 |
| 35 | | | | | | 35 | 8.64 | | | | | 35 | 4.56 |
| 36 | | | | | | 36 | 9.81 | | | | | 36 | 4.64 |
| 37 | | | | | | | | | | | | 37 | 4.73 |
| 38 | | | | | | | | | | | | 38 | 4.83 |
| 39 | | | | | | | | | | | | 39 | 4.95 |
| 40 | | | | | | | | | | | | 40 | 5.10 |
| 41 | | | | | | | | | | | | 41 | 5.28 |
| 42 | | | | | | | | | | | | 42 | 5.56 |
| 43 | | | | | | | | | | | | 43 | 6.13 |
| 44 | | | | | | | | | | | | 44 | 8.34 |
| 45 | | | | | | | | | | | | 45 | 9.65 |

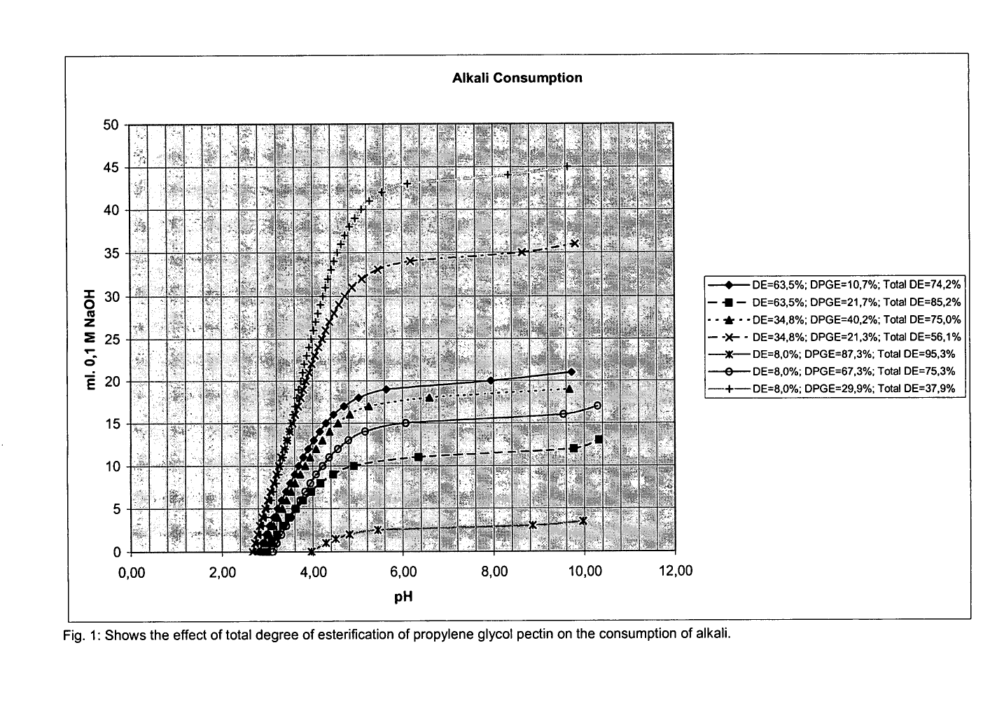

The results set forth in table 2, above, are graphed in FIG. 1.

As can be seen from FIG. 1, the alkali consumption (or alternatively the buffer capacity) of propylene glycol pectin decreases with the total degree of esterification. This follows the findings with methylated pectin and propylene glycol alginate. Thus, the buffer capacity is related to the degree of free acid groups in the

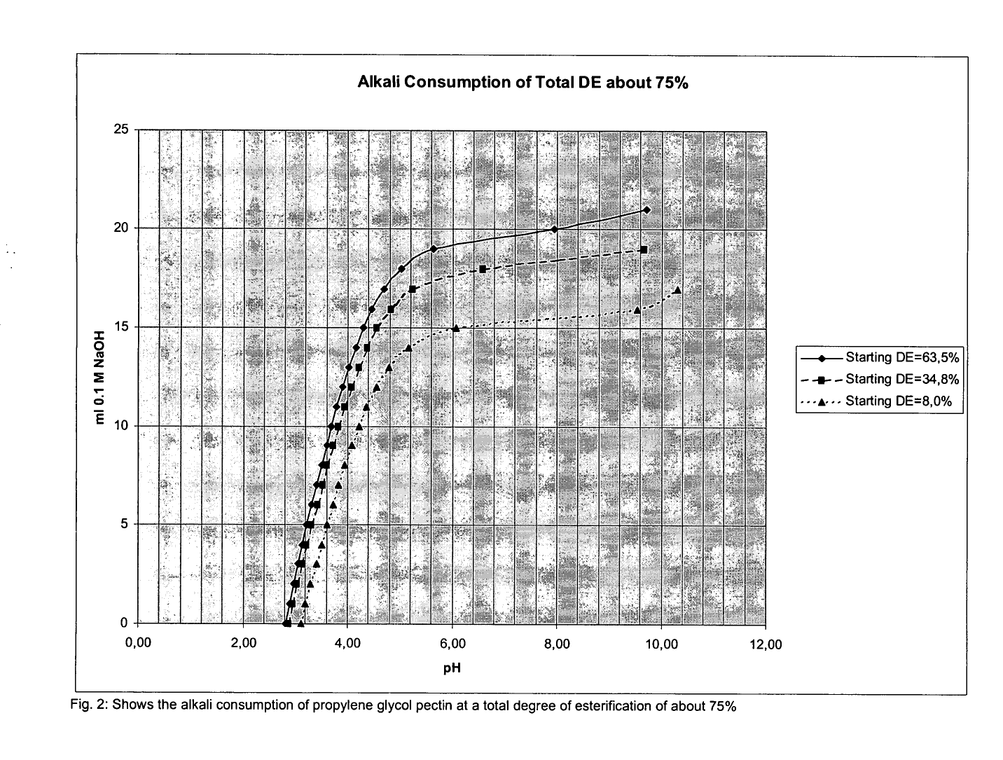

FIG. 2 is a detail of FIG. 1, showing the titration curve for samples from reactions 1, 3, and 6. All of these samples have approximately the same DE (about 75%). What distinguishes them is the degree of propylene glycol esterification (“DPGE”). The sample from reaction 1 has a DPGE of 10.7; the sample from reaction 3 has a DPGE of 40.2; the sample from reaction 6 has a DPGE of 67.3. As can be seen in FIG. 2, it appears that at equal total degrees of esterification, the alkali consumption increases with decreasing degree of propylene glycol esterification.

### Example 2

### Ability to Reduce pH

Portions of the same seven samples were then evaluated for their ability to reduce pH in a pH drop measurement. The pH drop was measured by the following experimental procedure:

Procedure for Determining the pH-Drop

1. 1 g pectin was dissolved in 100 g deionized water at a specified dissolve temperature.

2. The solution was placed in a thermostatically controlled water bath and continuously stirred.

3. 0.1 M NaOH was added to a pH of between 9 and 10.

4. The pH was recorded as a function of time.

The results of the measurements are set forth in Table 3, below.

TABLE 3

| Reaction | | Reaction | | Reaction | | Reaction | | Reaction | | Reaction | | Reaction | |
|---|---|---|---|---|---|---|---|---|---|---|---|---|---|
| Sample 1 | | Sample 2 | | Sample 3 | | Sample 4 | | Sample 5 | | Sample 6 | | Sample 7 | |
| min | pH | min | pH | min | pH | min | pH | min | pH | min | pH | min | pH |
| 0 | 10.02 | 0 | 10.02 | 0 | 10.20 | 0 | 10.06 | 0 | 10.09 | 0 | 10.37 | 0 | 10.17 |
| 1 | 9.70 | 1 | 9.47 | 1 | 9.88 | 1 | 9.91 | 1 | 9.45 | 1 | 9.98 | 1 | 10.04 |
| 2 | 9.47 | 2 | 9.11 | 2 | 9.64 | 2 | 9.80 | 2 | 9.03 | 2 | 9.72 | 2 | 9.95 |
| 3 | 9.29 | 3 | 8.83 | 3 | 9.47 | 3 | 9.72 | 3 | 8.70 | 3 | 9.52 | 3 | 9.87 |
| 4 | 9.14 | 4 | 8.60 | 4 | 9.32 | 4 | 9.64 | 4 | 8.45 | 4 | 9.36 | 4 | 9.80 |
| 5 | 9.01 | 5 | 8.43 | 5 | 9.19 | 5 | 9.57 | 5 | 8.24 | 5 | 9.22 | 5 | 9.75 |
| 10 | 8.50 | 10 | 7.88 | 10 | 8.69 | 10 | 9.24 | 10 | 7.75 | 10 | 8.70 | 10 | 9.52 |
| 20 | 7.95 | 15 | 7.64 | 15 | 8.27 | 20 | 8.73 | 20 | 7.33 | 21 | 8.03 | 20 | 9.23 |
| 30 | 7.73 | 30 | 7.38 | 25 | 7.82 | 40 | 8.16 | 40 | 7.07 | 40 | 7.66 | 50 | 8.69 |
| 45 | 7.58 | 50 | 7.26 | 35 | 7.64 | 80 | 7.77 | 65 | 6.96 | 71 | 7.46 | 80 | 8.22 |
| 59 | 7.50 | 65 | 7.21 | 75 | 7.45 | 110 | 7.66 | 90 | 6.87 | 100 | 7.41 | 110 | 7.99 |
| 79 | 7.40 | 100 | 7.14 | 105 | 7.35 | 135 | 7.63 | 120 | 6.81 | 118 | 7.38 | | |
| 154 | 7.32 | | | | | | | | | | | | |

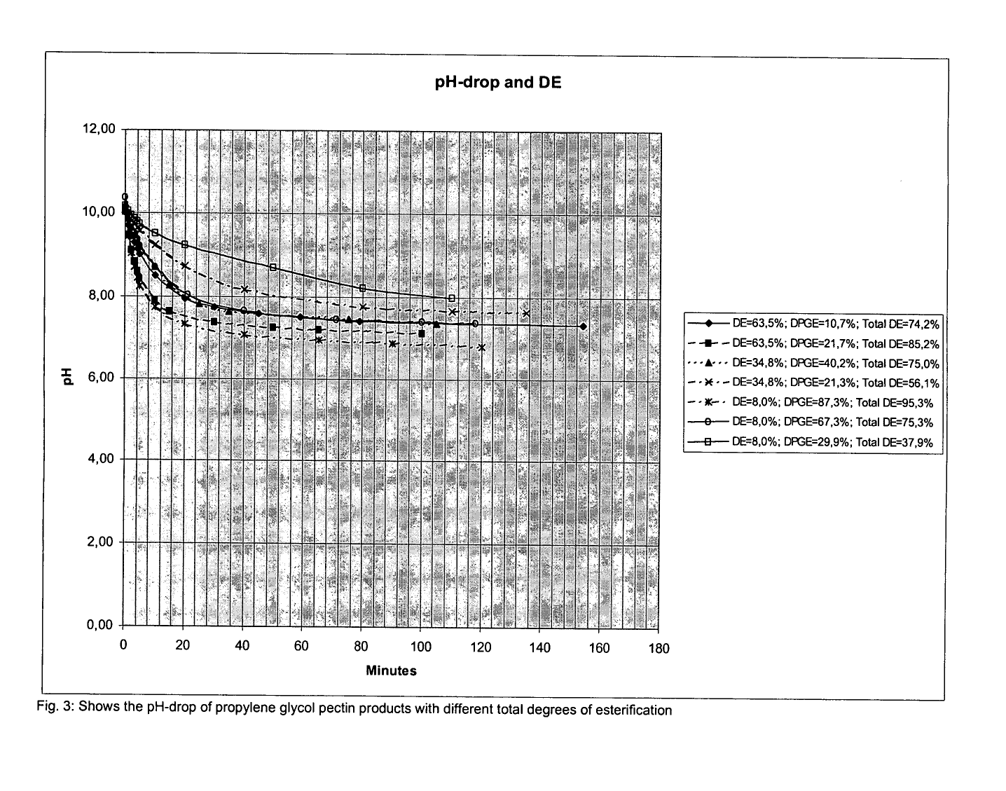

The results set forth in Table 3, above, are graphed in FIG. 3.

As can be seen in FIG. 3, the pH-drop increases with the increasing total degree of esterification. Thus, in this respect propylene glycol pectin behaves like methylated pectin and propylene glycol alginate.

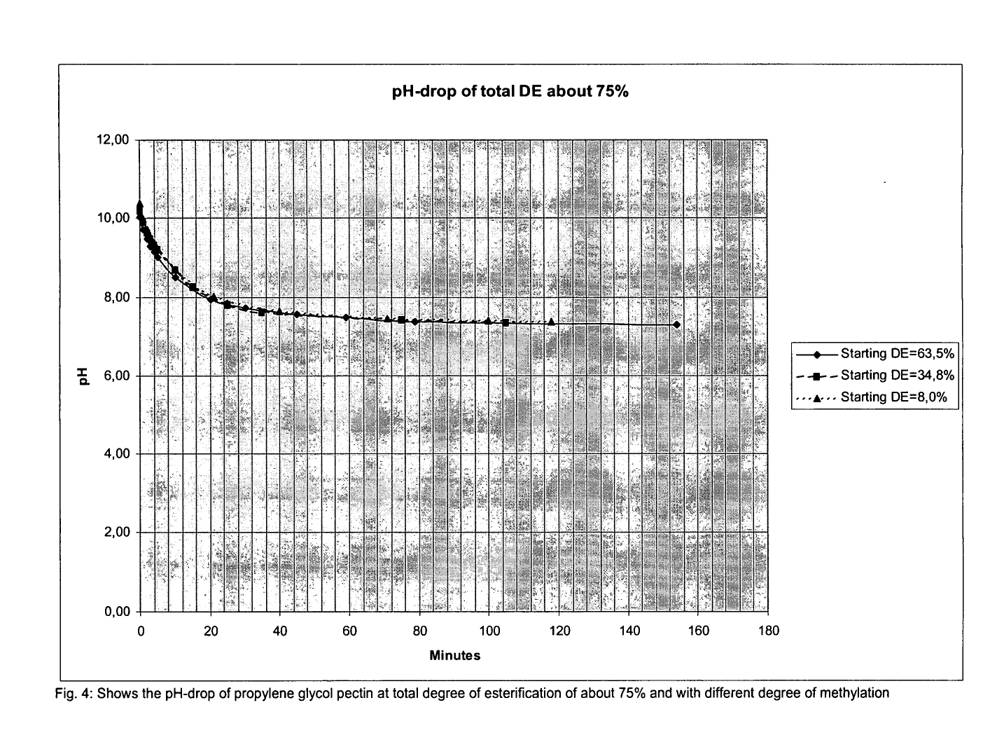

FIG. 4 is a detail of FIG. 3, showing the pH drop curves for three samples from reactions 1, 3, and 6. All of these samples had propylene glycol pectin of about the same DE (about 75%), but each of these samples was prepared from pectin material having differents DEs. As can be seen in FIG. 4, all of these samples have near identical pH drop performance as shown by the near-overlapping curves in FIG. 4. This indicates that the pH-drop is independent of the original degree of methylation of the starting pectin product.

### Example 3

### Effect of Temperature

Samples from reaction 6 were then studied further to determine the effect of temperature during pH reduction. Measurements were made according to the “Procedure for Determining the pH-drop” set forth above, but with the temperature maintained within two distinct temperature ranges: the pH recordation in step (4) is done at two separate temperature ranges of 30-32° C. and 45-47° C. The results are set forth in Table 4, below.

TABLE 4

| | |
|---|---|
| Reaction | Reaction |
| Sample 6 | Sample 6 |
| At 30-32° C. | At 45-47° C. |

| min | pH | min | pH |
|---|---|---|---|
| 0 | 10.37 | 0 | 10.12 |
| 1 | 9.98 | 1 | 9.39 |
| 2 | 9.72 | 2 | 8.94 |
| 3 | 9.52 | 3 | 8.60 |
| 4 | 9.36 | 4 | 8.34 |
| 5 | 9.22 | 5 | 8.13 |
| 10 | 8.70 | 6 | 7.97 |
| 21 | 8.03 | 11 | 7.59 |
| 40 | 7.66 | 21 | 7.32 |
| 71 | 7.46 | 41 | 7.18 |
| 100 | 7.41 | 71 | 7.11 |
| 118 | 7.38 | 101 | 7.04 |

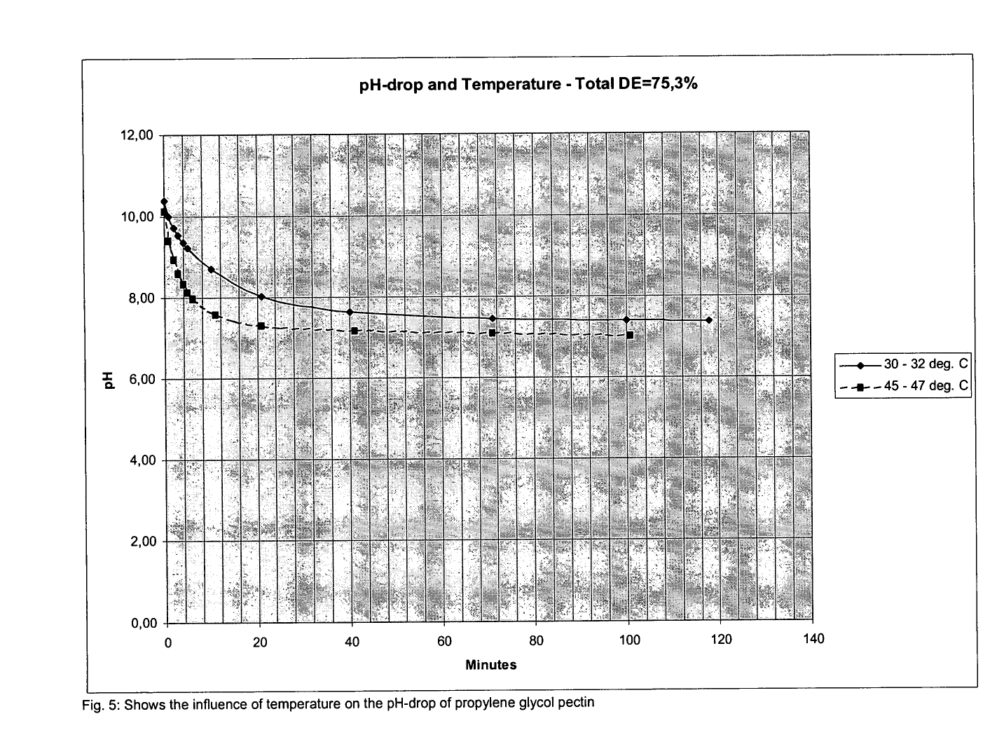

The results set forth in Table 4, above, are graphed in FIG. 5.

As can be seen in FIG. 5, for the two identical samples, pH drop is faster at the higher temperature. Thus, propylene glycol pectin, like methylated pectin and propylene glycol alginate, deesterifies faster with higher temperatures, thus causing a faster drop in pH as the temperature is increased.

### Example 4

### Effect of the Dissolution Temperature

Samples from reaction 7 were then studied further to determine the effect of the dissolution temperature. Measurements were made according to the “Procedure for Determining the pH-drop” set forth above, with the dissolution temperature in step 1 being done at two different temperatures: 25° C. and 70° C. The results are set forth in Table 5, below.

TABLE 5

| | |
|---|---|
| Reaction | Reaction |
| Sample 7 | Sample 7 |
| At 70° C. | At 25° C. |

| min | pH | min | pH |
|---|---|---|---|
| 0 | 10.17 | 0 | 10.18 |
| 1 | 10.04 | 1 | 10.08 |
| 2 | 9.95 | 2 | 10.03 |
| 3 | 9.87 | 3 | 9.96 |
| 4 | 9.80 | 4 | 9.91 |
| 5 | 9.75 | 5 | 9.86 |
| 10 | 9.52 | 10 | 9.67 |
| 20 | 9.23 | 20 | 9.42 |
| 50 | 8.69 | 40 | 8.99 |
| 80 | 8.22 | 70 | 8.54 |
| 110 | 7.99 | 100 | 8.22 |
| | | 120 | 8.04 |

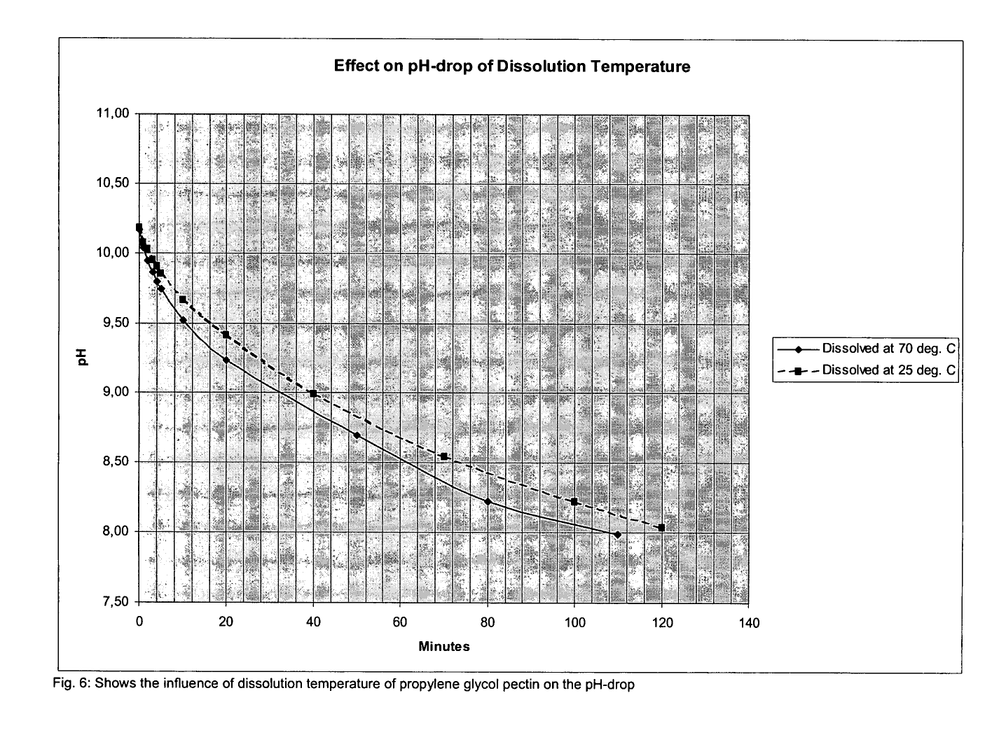

The result set forth in Table 5, above, are graphed in FIG. 6.

As can be seen in FIG. 6, it appears that the Dissolution at 70° C. provides for a somewhat faster pH-drop than if propylene glycol pectin is dissolved at 25° C. It is believed that this is an indication that propylene glycol pectin is not completely soluble at room temperature, which is contrary to methylated pectin and

### Example 5

### Effect of Propylene Glycol Pectin Concentration

Samples from reaction 7 were then studied further to determine the effect of propylene glycol pectin concentration. Measurements were made according to the “Procedure for Determining the pH-drop” set forth above, with the concentration of the propylene glycol pectin varied to 0.5%, 1.0%, and 2.0%. The pH was then measured in step (4) at room temperature. The results are set forth in Table 6, below.

TABLE 6

| | | | | | | 4 | | 5 | | | |
|---|---|---|---|---|---|---|---|---|---|---|---|
| 1 | | 2 | | 3 | | 0.50% | | 1.00% | | 6 | |
| 0.50% | | 1.00% | | 2.00% | | Reaction 7 | | Reaction 7 | | 2.00% | |
| Reaction 7 | | Reaction 7 | | Reaction 7 | | Sample | | Sample | | Reaction 7 | |
| Sample | | Sample | | Sample | | | pH- | | pH- | Sample | |
| min | pH | min | pH | min | pH | min | Index | min | Index | min | pH-Index |
| 0 | 9.79 | 0 | 10.37 | 0 | 9.96 | 0 | 100 | 0 | 100 | 0 | 100 |
| 1 | 9.62 | 1 | 9.98 | 1 | 9.52 | 1 | 98 | 1 | 96 | 1 | 96 |
| 2 | 9.49 | 2 | 9.72 | 2 | 9.22 | 2 | 97 | 2 | 94 | 2 | 93 |
| 3 | 9.37 | 3 | 9.52 | 3 | 9.00 | 3 | 96 | 3 | 92 | 3 | 90 |
| 4 | 9.26 | 4 | 9.36 | 4 | 8.81 | 4 | 95 | 4 | 90 | 4 | 88 |
| 5 | 9.18 | 5 | 9.22 | 5 | 8.64 | 5 | 94 | 5 | 89 | 5 | 87 |
| 10 | 8.69 | 10 | 8.70 | 10 | 8.08 | 10 | 89 | 10 | 84 | 10 | 81 |
| 20 | 8.00 | 21 | 8.03 | 20 | 7.69 | 20 | 82 | 21 | 77 | 20 | 77 |
| 40 | 7.54 | 40 | 7.66 | 40 | 7.49 | 40 | 77 | 40 | 74 | 40 | 75 |
| 70 | 7.36 | 71 | 7.46 | 70 | 7.37 | 70 | 75 | 71 | 72 | 70 | 74 |
| 100 | 7.28 | 100 | 7.41 | 90 | 7.28 | 100 | 74 | 100 | 71 | 90 | 73 |
| 120 | 7.26 | 118 | 7.38 | 120 | 7.24 | 120 | 74 | 118 | 71 | 120 | 73 |

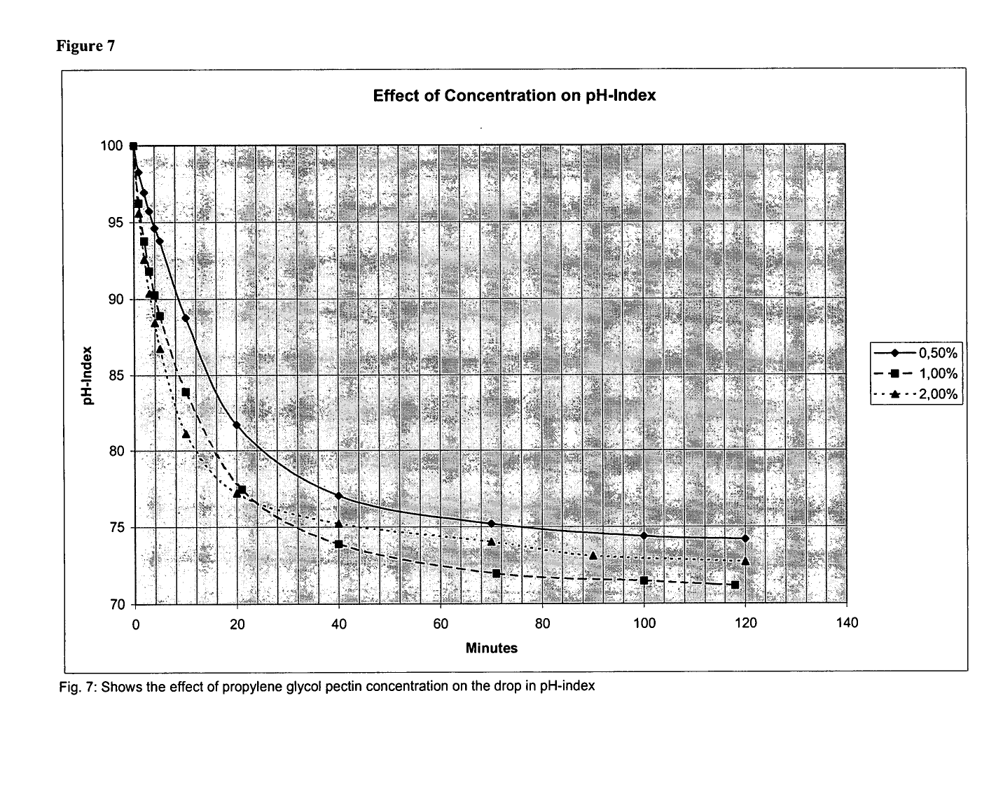

The data in columns 1-3 represented actual data measured. However, since it is difficult to precisely adjust the pH for the same starting value across several different samples (see the variation in the pH at t=0 minutes in columns 1-3), a pH index was calculated. For each sample in columns 4-6, the pH at t=0 min was set to 100. These index values are then plotted in FIG. 7.

As can be seen in FIG. 7, the pH drop increases with increasing concentration of propylene glycol pectin. This effect is pronounced when increasing the concentration from 0.50% to 1.0%; however, the pH drop increase sees only a slight acceleration when concentration is increased further from 1.0% to 2.0%. Thus, propylene glycol pectin appears to provide optimal pH-drop at about 1.0% concentration.

### Example 6

### Effect of Multiple Additions of Alkali

A sample of the propylene glycol pectin produced in reaction 5 was run through three additions of alkali. First, the pH was raised to about 10. After one hour at 30-32° C., the pH was once more increased to about 10, and after an additional hour at 30-32° C., the pH was raised to about 10 for a third time and the sample left at 30-32° C. for yet one hour. Two seperate tests were run. In one set, the propylene glycol pectin was dissolved in deionized water at 25° C. (step 1 of the “Procedure for Determining the pH-drop”) and in another the dissolution temperature was set to 70° C. The results are set forth in Table 7, below.

TABLE 7

| Dissolved at 25° C. | | | | | | Dissolved at 70° C. | | | | | |
|---|---|---|---|---|---|---|---|---|---|---|---|
| First | | Second | | Third | | First | | Second | | Third | |
| cycle | | cycle | | cycle | | cycle | | cycle | | cycle | |
| ml. 0.1 | | ml. 0.1 | | ml. 0.1 | | ml. 0.1 | | ml. 0.1 | | ml. 0.1 | |
| M = 1.9 | | M = 0.7 | | M = 0.7 | | M = 2.1 | | M = 0.7 | | M = 0.7 | |
| Reaction | | Reaction | | Reaction | | Reaction | | Reaction | | Reaction | |
| 5 Sample | | 5 Sample | | 5 Sample | | 5 Sample | | 5 Sample | | 5 Sample | |
| min | pH | min | pH | min | pH | min | pH | min | pH | min | pH |
| 0 | 10.00 | 0 | 9.77 | 0 | 10.01 | 0 | 10.35 | 0 | 10.13 | 0 | 10.11 |
| 1 | 9.28 | 1 | 9.23 | 1 | 9.49 | 1 | 9.59 | 1 | 9.63 | 1 | 9.65 |
| 2 | 8.81 | 2 | 8.85 | 2 | 9.11 | 2 | 9.07 | 2 | 9.27 | 2 | 9.34 |
| 3 | 8.47 | 3 | 8.56 | 3 | 8.82 | 3 | 8.70 | 3 | 8.99 | 3 | 9.07 |
| 4 | 8.21 | 4 | 8.32 | 4 | 8.57 | 4 | 8.40 | 4 | 8.76 | 4 | 8.85 |
| 5 | 8.02 | 5 | 8.14 | 5 | 8.37 | 5 | 8.18 | 5 | 8.57 | 5 | 8.67 |
| 10 | 7.57 | 10 | 7.66 | 10 | 7.80 | 10 | 7.63 | 10 | 7.95 | 10 | 8.06 |
| 20 | 7.26 | 20 | 7.36 | 20 | 7.43 | 20 | 7.30 | 20 | 7.45 | 20 | 7.59 |
| 30 | 7.14 | 30 | 7.23 | 30 | 7.31 | 30 | 7.16 | 30 | 7.28 | 30 | 7.36 |
| 40 | 7.05 | 40 | 7.16 | 40 | 7.23 | 40 | 7.08 | 40 | 7.19 | 40 | 7.26 |
| 60 | 6.92 | 60 | 7.03 | 60 | 7.15 | 60 | 6.99 | 60 | 7.10 | 60 | 7.18 |
| Dissolved at 25° C. | | | | | | Dissolved at 70° C. | | | | | |
| First | | Second | | Third | | First | | Second | | Third | |
| cycle | | cycle | | cycle | | cycle | | cycle | | cycle | |
| ml. 0.1 | | ml. 0.1 | | ml. 0.1 | | ml. 0.1 | | ml. 0.1 | | ml. 0.1 | |
| M = 1.9 | | M = 0.7 | | M = 0.7 | | M = 2.1 | | M = 0.7 | | M = 0.7 | |
| Reaction | | Reaction | | Reaction | | Reaction | | Reaction | | Reaction | |
| 5 Sample | | 5 Sample | | 5 Sample | | 5 Sample | | 5 Sample | | 5 Sample | |
| | pH- | | pH- | | pH- | | pH- | | pH- | | pH- |
| min | Index | min | Index | min | Index | min | Index | min | Index | min | Index |
| 0 | 100 | 0 | 100 | 0 | 100 | 0 | 100 | 0 | 100 | 0 | 100 |
| 1 | 93 | 1 | 94 | 1 | 95 | 1 | 93 | 1 | 95 | 1 | 95 |
| 2 | 88 | 2 | 91 | 2 | 91 | 2 | 88 | 2 | 92 | 2 | 92 |
| 3 | 85 | 3 | 88 | 3 | 88 | 3 | 84 | 3 | 89 | 3 | 90 |
| 4 | 82 | 4 | 85 | 4 | 86 | 4 | 81 | 4 | 86 | 4 | 88 |
| 5 | 80 | 5 | 83 | 5 | 84 | 5 | 79 | 5 | 85 | 5 | 86 |
| 10 | 76 | 10 | 78 | 10 | 78 | 10 | 74 | 10 | 78 | 10 | 80 |
| 20 | 73 | 20 | 75 | 20 | 74 | 20 | 71 | 20 | 74 | 20 | 75 |
| 30 | 71 | 30 | 74 | 30 | 73 | 30 | 69 | 30 | 72 | 30 | 73 |
| 40 | 71 | 40 | 73 | 40 | 72 | 40 | 68 | 40 | 71 | 40 | 72 |
| 60 | 69 | 60 | 72 | 60 | 71 | 60 | 68 | 60 | 70 | 60 | 71 |

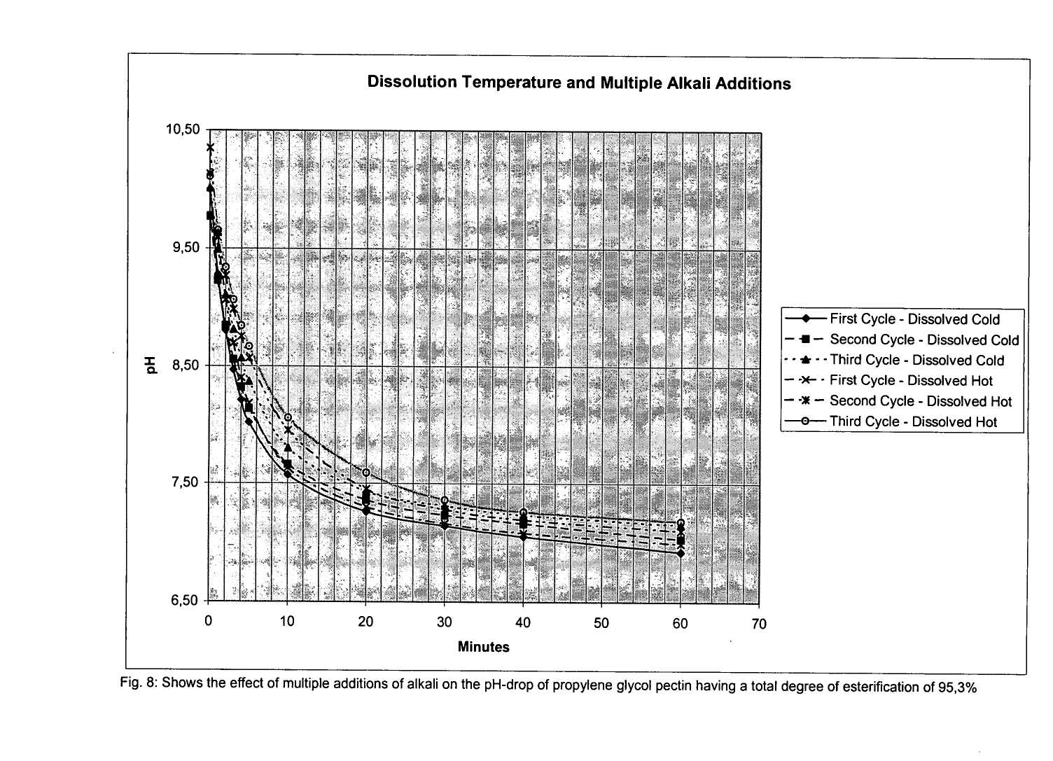

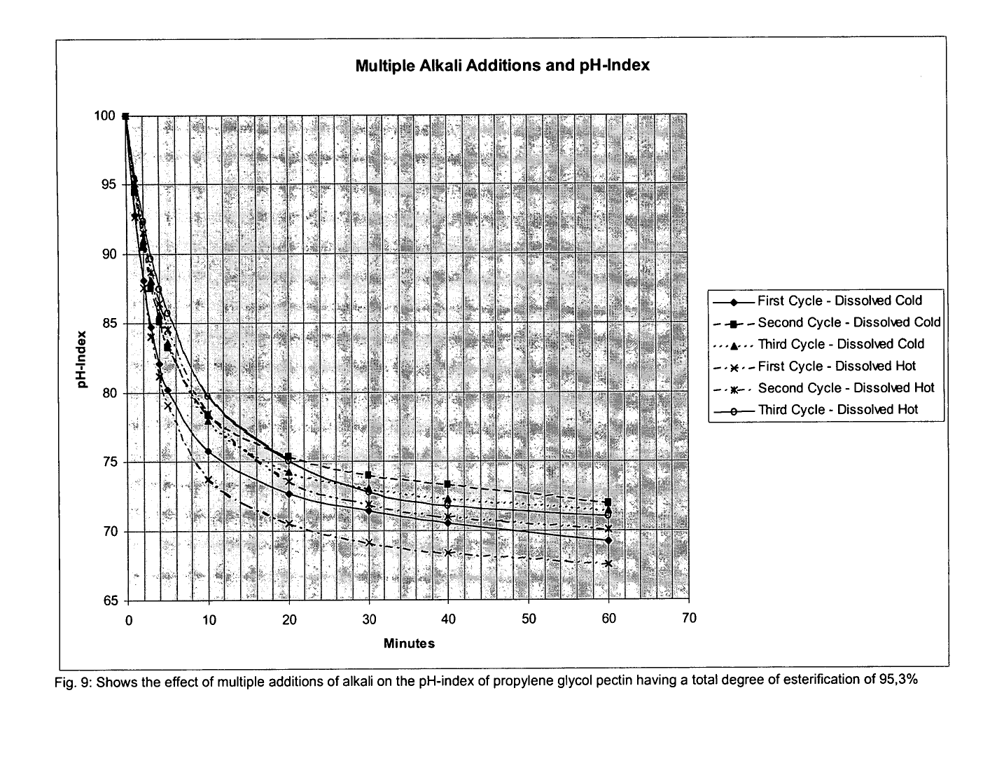

As above, pH-indices were calculated from the actual data. The actual data is plotted in FIG. 8; the pH-indices are plotted in FIG. 9.

As can be seen in FIGS. 8 and 9, as the propylene glycol ester is being removed by alkali, the pH-drop deccelerates. Thus, during multiple additions of the alkali, the pH-drop experiences a gradual and continous decceleration. It is also apparent that there is a difference between preparations dissolved at 25° C. and at 70° C., the 70° C. dissolved propylene glycol pectin providing for a faster pH-drop. This is believed to reflect that propylene glycol pectin is not completely cold soluble.

### Example 7

### Performance Comparison with Methylated Pectin and Propylene glycol alginate

Finally, the alkali consumption and the pH drop of the Propylene glycol pectin was compared to the alkali consumption and the pH drop of methylated pectin and Propylene glycol alginate. The data for methylated pectin and propylene glycol aligante is taken from Danish Patent Application No. PA 2004/00649, now also PCT Patent Application DK2005/000285. In all cases, the samples were dissolved in deionized water at 70° C. and tested and measured according to the Titration curves procedure, (Table 8, below) and the “Procedure for Determining the pH-drop” (Table 9, below).

TABLE 8

| | | | | | | | | | | | | Propylene | |
|---|---|---|---|---|---|---|---|---|---|---|---|---|---|
| | | | | | | | | | | | | glycol | |
| | | | | | | Propylene glycol pectin | | | | | | alginate | |
| Methylated pectin | | | | | | Reaction | | Reaction | | Reaction | | DE = 80% | |
| DE = 34.4% | | DE = 71% | | DE = 93.4% | | Sample 7 | | Sample 1 | | Sample 6 | | ml | |
| ml 0.1 M | pH | ml 0.1 M | pH | ml 0.1 M | pH | ml 0.1 M | pH | ml 0.1 M | pH | ml 0.1 M | pH | 0.1 M | pH |
| 0 | 3.22 | 0 | 3.11 | 0 | 3.26 | 0 | 2.73 | 0 | 2.81 | 0 | 3.96 | 0 | 3.89 |
| 1 | 3.27 | 0.2 | 3.12 | 1 | 3.43 | 1 | 2.78 | 1 | 2.89 | 1 | 4.28 | 0.5 | 3.99 |
| 2 | 3.30 | 0.42 | 3.14 | 2 | 3.65 | 2 | 2.84 | 2 | 2.97 | 1.5 | 4.50 | 1 | 4.1 |
| 3 | 3.33 | 0.6 | 3.15 | 3 | 3.98 | 3 | 2.90 | 3 | 3.05 | 2 | 4.81 | 1.5 | 4.22 |
| 4 | 3.36 | 0.84 | 3.17 | 4 | 4.54 | 4 | 2.96 | 4 | 3.14 | 2.5 | 5.44 | 2 | 4.38 |
| 5 | 3.39 | 1.2 | 3.20 | 5 | 8.74 | 5 | 3.02 | 5 | 3.22 | 3 | 8.85 | 2.5 | 4.57 |
| 6 | 3.42 | 1.6 | 3.23 | | | 6 | 3.08 | 6 | 3.31 | 3.5 | 9.96 | 3 | 4.89 |
| 7 | 3.45 | 2.08 | 3.27 | | | 7 | 3.13 | 7 | 3.41 | | | 3.5 | 5.7 |
| 8 | 3.48 | 2.4 | 3.29 | | | 8 | 3.19 | 8 | 3.50 | | | 4 | 8.82 |
| 9 | 3.51 | 3 | 3.34 | | | 9 | 3.24 | 9 | 3.60 | | | | |
| 10 | 3.55 | 3.4 | 3.37 | | | 10 | 3.29 | 10 | 3.69 | | | | |
| 11 | 3.58 | 4 | 3.42 | | | 11 | 3.34 | 11 | 3.79 | | | | |
| 12 | 3.62 | 4.8 | 3.49 | | | 12 | 3.39 | 12 | 3.90 | | | | |
| 13 | 3.65 | 5.68 | 3.56 | | | 13 | 3.43 | 13 | 4.02 | | | | |
| 14 | 3.69 | 6.02 | 3.59 | | | 14 | 3.48 | 14 | 4.15 | | | | |
| 15 | 3.74 | 6.6 | 3.64 | | | 15 | 3.52 | 15 | 4.29 | | | | |
| 16 | 3.77 | 7.6 | 3.73 | | | 16 | 3.56 | 16 | 4.46 | | | | |
| 17 | 3.82 | 8 | 3.76 | | | 17 | 3.61 | 17 | 4.69 | | | | |
| 18 | 3.86 | 9 | 3.86 | | | 18 | 3.65 | 18 | 5.02 | | | | |
| 19 | 3.90 | 10 | 3.97 | | | 19 | 3.69 | 19 | 5.64 | | | | |
| 20 | 3.94 | 10.4 | 4.00 | | | 20 | 3.74 | 20 | 7.94 | | | | |
| 21 | 3.98 | 11 | 4.07 | | | 21 | 3.78 | 21 | 9.72 | | | | |
| 22 | 4.03 | 12 | 4.20 | | | 22 | 3.82 | | | | | | |
| 23 | 4.08 | 13 | 4.34 | | | 23 | 3.87 | | | | | | |
| 24 | 4.13 | 14 | 4.52 | | | 24 | 3.92 | | | | | | |
| 25 | 4.17 | 15 | 4.73 | | | 25 | 3.97 | | | | | | |
| 26 | 4.23 | 16 | 5.08 | | | 26 | 4.02 | | | | | | |
| 27 | 4.28 | 16.6 | 5.43 | | | 27 | 4.07 | | | | | | |
| 28 | 4.34 | 17 | 5.95 | | | 28 | 4.12 | | | | | | |
| 29 | 4.40 | 17.4 | 8.12 | | | 29 | 4.18 | | | | | | |
| 30 | 4.47 | 17.6 | 9.00 | | | 30 | 4.23 | | | | | | |
| 31 | 4.54 | | | | | 31 | 4.29 | | | | | | |
| 33 | 4.72 | | | | | 32 | 4.35 | | | | | | |
| 35 | 4.97 | | | | | 33 | 4.42 | | | | | | |
| 36 | 5.16 | | | | | 34 | 4.48 | | | | | | |
| 37 | 5.45 | | | | | 35 | 4.56 | | | | | | |
| 38 | 6.20 | | | | | 36 | 4.64 | | | | | | |
| 39 | 9.76 | | | | | 37 | 4.73 | | | | | | |
| | | | | | | 38 | 4.83 | | | | | | |
| | | | | | | 39 | 4.95 | | | | | | |
| | | | | | | 40 | 5.10 | | | | | | |
| | | | | | | 41 | 5.28 | | | | | | |
| | | | | | | 42 | 5.56 | | | | | | |
| | | | | | | 43 | 6.13 | | | | | | |
| | | | | | | 44 | 8.34 | | | | | | |
| | | | | | | 45 | 9.65 | | | | | | |

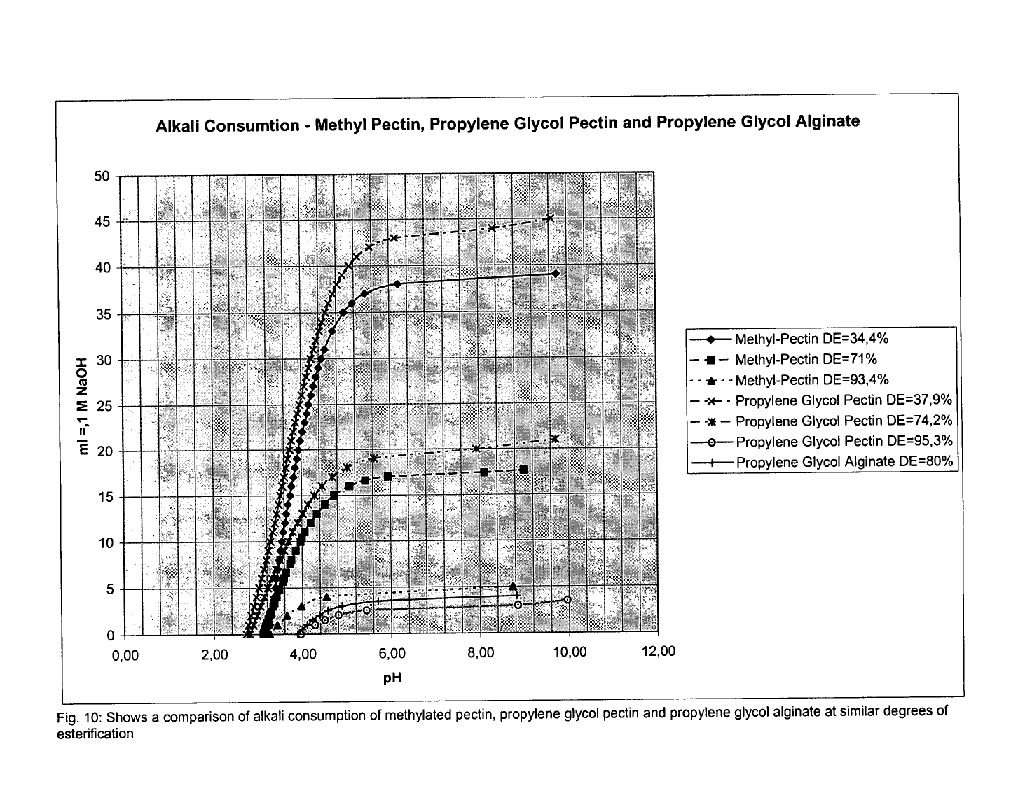

The titration curve from the Table 8 data is graphed in FIG. 10

TABLE 9

| | | | | | | | | | | | | Propylene | |
|---|---|---|---|---|---|---|---|---|---|---|---|---|---|
| | | | | | | Propylene glycol pectin | | | | | | glycol | |
| Methylated pectin | | | | | | Reaction | | Reaction | | Reaction | | alginate | |
| DE = 34.4% | | DE = 71% | | DE = 93.4% | | Sample 7 | | Sample 1 | | Sample 6 | | DE = 80% | |
| Min | pH | Min | pH | Min. | pH | Min | pH | Min | pH | Min | pH | Min | pH |
| 0 | 9.97 | 0 | 10.21 | 0 | 9.50 | 0 | 10.17 | 0 | 10.02 | 0 | 10.09 | 0 | 10.00 |
| 1 | 9.74 | 0.5 | 9.85 | 1 | 8.89 | 1 | 10.04 | 1 | 9.70 | 1 | 9.45 | 1 | 7.77 |
| 2 | 9.59 | 1 | 9.65 | 2 | 8.14 | 2 | 9.95 | 2 | 9.47 | 2 | 9.03 | 2 | 7.34 |
| 3 | 9.48 | 2 | 9.35 | 3 | 7.77 | 3 | 9.87 | 3 | 9.29 | 3 | 8.70 | 3 | 7.14 |
| 4 | 9.37 | 3 | 9.10 | 4 | 7.58 | 4 | 9.80 | 4 | 9.14 | 4 | 8.45 | 4 | 7.00 |
| 5 | 9.28 | 8 | 8.39 | 5 | 7.45 | 5 | 9.75 | 5 | 9.01 | 5 | 8.24 | 5 | 6.89 |
| 35 | 8.01 | 10 | 8.21 | 11 | 7.04 | 10 | 9.52 | 10 | 8.50 | 10 | 7.75 | 10 | 6.48 |
| 67 | 7.59 | 20 | 7.73 | 15 | 6.90 | 20 | 9.23 | 20 | 7.95 | 20 | 7.33 | 15 | 6.20 |
| 110 | 7.33 | 31 | 7.50 | 20 | 6.79 | 50 | 8.69 | 30 | 7.73 | 40 | 7.07 | 25 | 5.81 |
| | | 45 | 7.30 | 25 | 6.70 | 80 | 8.22 | 45 | 7.58 | 65 | 6.96 | 53 | 5.29 |
| | | 75 | 7.12 | 30 | 6.62 | 110 | 7.99 | 59 | 7.50 | 90 | 6.87 | 70 | 5.12 |
| | | 115 | 7.00 | 38 | 6.52 | | | 79 | 7.40 | 120 | 6.81 | 90 | 4.99 |
| | | | | | | | | 154 | 7.32 | | | 116 | 4.89 |
| | | | | | | | | | | | | 127 | 4.85 |

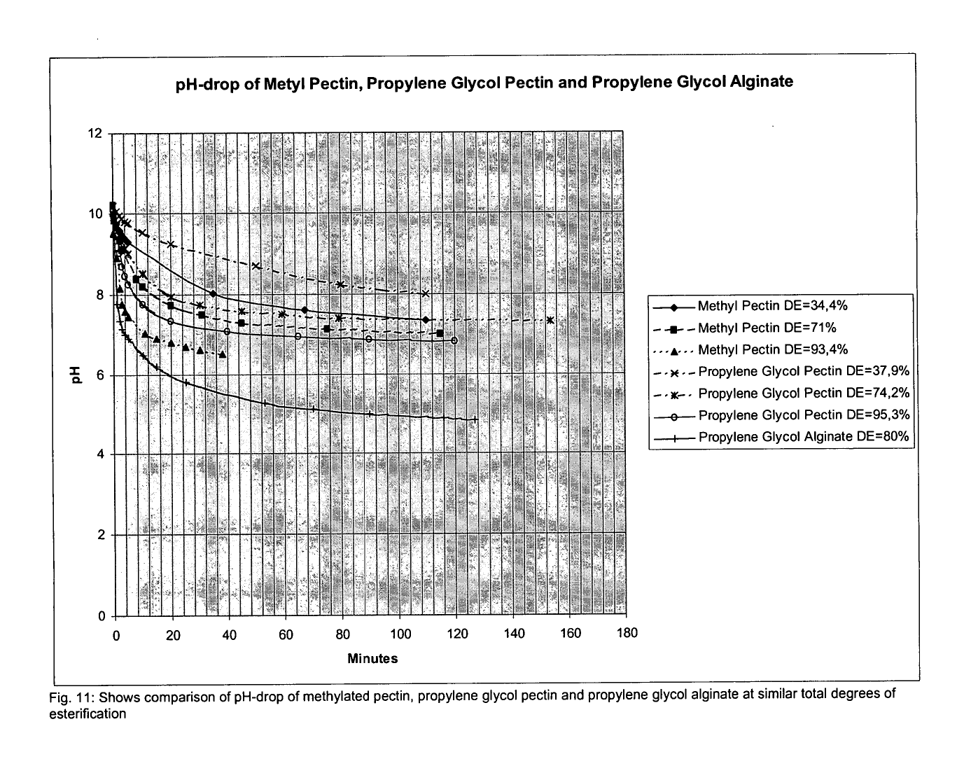

The pH drop shown in Table 9 is plotted in FIG. 11.

As can be seen in Table 8 and FIG. 10, propylene glycol pectin prepared according to the present invention provides a higher level of alkali consumption than methylated pectin at similar total degree of esterification. Similarly there is a clear superior of alkali consumption between propylene glycol pectin and propylene glycol alginate, with propylene glycol pectin providing a significantly higher level of alkali consumption.

However, as can be seen in Table 9 and FIG. 11, propylene glycol alginate is more effective in reducing pH than methylated pectin, which in turn is more effective than propylene glycol pectin. Nonetheless, using propylene oxide it is still possible to achieve higher degrees of esterification than what is possible using conventional techniques for producing methylated pectin. Thus, propylene glycol pectin having a total degree of esterification of above 90% is easily achievable, and provides a higher effect than conventionally produced methylated pectin having a degree of esterification of about 70%.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A skin-protecting alkalinity-controlling composition comprising propylene glycol pectin having a degree of esterification in the range from about 30% to about 100%.

2. The skin-protecting alkalinity-controlling composition according to claim 1, wherein the propylene glycol pectin has a degree of esterification in the range from about 80% to about 100%.

3. The skin-protecting alkalinity-controlling composition according to claim 1, wherein said propylene glycol pectin has a molecular weight in the range from about 5,000 to about 140,000.

4. The skin-protecting alkalinity-controlling composition according to claim 1, wherein the propylene glycol pectin is present in a concentration of about 0.1% to about 2%.

5. The skin-protecting alkalinity-controlling composition according to claim 4, wherein the propylene glycol pectin is present in a concentration of about 0.1% to about 1%

6. The skin-protecting alkalinity-controlling composition according to claim 1, further comprising a low DE carboxylic acid polysaccharide having a degree of esterification (DE) in the range from about 5 to about 70%.

7. The skin-protecting alkalinity-controlling composition according to claim 5, wherein the low DE carboxylic acid polysaccharide has DE of about 10% to about 35%.

8. The skin-protecting alkalinity-controlling composition according to claim 6, wherein the low DE carboxylic acid polysaccharide is selected from the group comprising pectin esters, alginic acid esters, esterified cellulose ethers, esterified hydroxyethylcellulose, esterified carboxymethylcellulose, esterified guar gum, esterified cationic guar gum, esterified hydroxypropyl guar gum, starch esters, and polymerized sugar esters.

9. The skin-protecting alkalinity-controlling composition according to claim 1 which is in the form of a personal care product selected from the group comprising skin creams, skin lotions, deodorant products, fragrance products, hair care products, shaving products, soap products, and bath salt products.

10. The skin-protecting alkalinity-controlling composition according to claim 1, wherein the propylene glycol pectin has a degree of propylene glycol esterification (“DPGE”) of about 5% to about 100%.

11. The skin-protecting alkalinity-controlling composition according to claim 1, wherein the propylene glycol pectin has a DPGE of about 10% to about 90%.

12. The skin-protecting alkalinity-controlling composition according to claim 1, wherein the propylene glycol pectin has a DPGE of about 30% to about 90%.

13. The skin-protecting alkalinity-controlling composition according to claim 1, wherein the propylene glycol pectin has a DPGE of about 70% to about 90%.

14. A skin-protecting alkalinity-controlling composition comprising: (1) about 0.1% to about 2% of a propylene glycol pectin having a degree of esterification (DE) in the range from about 30% to about 100%, and a DPGE of about 5% to about 100%; and (2) a low DE carboxylic acid polysaccharide having a degree of esterification in the range from about 5% to about 70%.

15. The skin-protecting alkalinity-controlling composition according to claim 14, wherein the propylene glycol pectin has a degree of esterification in the range from about 80% to about 100%, and a DPGE of about 30% to about 90%.
